(19) United States
(12) Patent Application Publication
(10) Pub. No.: US 2023/0160206 A1
(43) Pub. Date: May 25, 2023

(54) Wall Construction with Laminated Insulation Panels and Spacer Boards Forming Insulative Air-Filled Voids

(71) Applicant: Bernard Ted Cullen, Winnipeg (CA)

(72) Inventor: Bernard Ted Cullen, Winnipeg (CA)

(21) Appl. No.: 17/990,929

(22) Filed: Nov. 21, 2022

Related U.S. Application Data
(60) Provisional application No. 63/283,261, filed on Nov. 25, 2021.

(51) Int. Cl. E04C 2/296; E04C 2/34; E04B 2/00; E04C 2/52; B32B 5/18; B32B 3/08; B32B 7/08; B32B 21/14; B32B 21/04; B32B 37/18; B32B 3/30

(52) U.S. Cl. CPC E04C 2/296; E04C 2/34; E04C 2/46; E04C 2/521; B32B 5/18; B32B 3/08; B32B 7/08; B32B 21/14; B32B 21/047; B32B 37/18; B32B 3/30; E04C 2002/3488; B32B 2607/00; B32B 2307/304; B32B 2307/732; B32B 2266/0228; B32B 2305/022; B32B 2317/16

(57) ABSTRACT

An exterior wall features interior and exterior insulation layers that comprise facer-laminated foam insulation panels having battens recessed into foam cores thereof at interior and exterior faces of the interior and exterior layers, respectively. A first set of spacer boards between the insulation layers provide an offset therebetween, and thereby create an array of air-filled void spaces for further insulative effect. At the interior side of the interior panels, a second set of spacer boards are installed for offset mounting of interior finishings (e.g. drywall) thereto, thereby creating another insulative array of air-filled void spaces between the interior insulation panels and the interior finishings. Exterior cladding placed directly over the exterior insulation panels is fastened to the battens thereof. On-site construction with a framing nailer is fast and convenient, creating a thermally efficient wall without need for batting insulation, poly sheeting vapour barrier, building wrap or exterior sheathing.

### CROSS-REFERENCE TO RELATED APPLICATIONS

This application claims benefit under 35 U.S.C. 119(e) of U.S. Provisional Application No. 63/282,261, filed Nov. 25, 2021, the entirety of which is incorporated herein by reference.

### FIELD OF THE INVENTION

This application relates generally to the design and construction of insulated exterior walls of a building.

### BACKGROUND

In general, but particularly in remote northern communities, there exits a notable demand for building materials and construction techniques for producing insulated exterior walls that embody highly insulative properties and suitable structural integrity, yet can be transported, assembled and erected in a time and cost-efficient manner. Disclosed herein is a unique insulated wall construction that Applicant believes can address such demand in a more effective manner than the prior solutions proposed heretofore.

### SUMMARY OF THE INVENTION

According to one aspect of the invention, there is provided a wall assembly comprising:

interior and exterior insulation layers that respectively comprise interior insulation panels and exterior insulation panels, of which both said interior insulation panels and said exterior insulations each have a foam core, two opposing faces, and plurality of perimeter edges, of which the two opposing faces of each interior insulation panel comprise an interior face that faces away from the exterior insulation layer and an outer face that faces toward the exterior insulation layer, while the two opposing faces of each exterior insulation panel comprise an exterior face that faces away from the interior insulation layer and an inner face that faces toward the interior insulation layer;

laminated onto the foam core of each of the interior insulation panels and the exterior insulation panels, at least one laminated facer respectively occupying at least one of the two opposing faces thereof;

a set of interior battens recessed into the foam cores of the interior insulation panels at the interior faces thereof;

a set of exterior battens recessed into the foam cores of the exterior insulation panels at the exterior faces thereof;

a set of spacer boards installed in an intermediate layer between the interior and exterior insulation layers;

a set of interior fasteners by which the interior battens and the spacer boards are interconnected;

a set of exterior fasteners by which the exterior battens and the spacer boards are interconnected; and

unoccupied void spaces bound between the spacer boards within the intermediate layer between the interior and exterior insulation panels.

According to another aspect of the invention, there is provided a method of assembling the wall assembly of any preceding claim, said method comprising:

laying a first one of either the interior insulation panels or the exterior insulation panels down atop a support in a batten-down orientation;

laying the spacer boards atop said first one of either the interior insulation panels or the exterior insulation panels, and fastening said spacer boards to the battens of said first one of either the interior insulation panels or the exterior insulation panels thereof through the foam cores thereof;

laying a second one of either the interior insulation panels or the exterior insulation panels atop the fastened spacer boards in a batten-up orientation, and fastening said second one of either the interior insulation panels or the exterior insulation panels to the fastened spacer boards through the foam cores of said second one of either the interior insulation panels or the exterior insulation panels, whereupon the interior insulation panels, the spacer boards and the exterior insulation panels are now fastened together into an assembled unit.

### BRIEF DESCRIPTION OF THE DRAWINGS

Preferred embodiments of the invention will now be described in conjunction with the accompanying drawings in which:

FIG. 1 is a perspective view of an assembled exterior wall constructed in accordance with a first embodiment of the present invention, as viewed from an exterior side thereof, and with an exterior insulation layer of the wall partially cut away at one end thereof.

FIG. 2 is another perspective view of the assembled exterior wall of FIG. 1 from an opposing interior side thereof.

FIG. 3 is a partial top perspective view of the assembled exterior wall of FIG. 1, as viewed from the exterior side thereof near the partially cut away end thereof.

FIG. 4 is an end perspective view of the assembled exterior wall of FIG. 1, as again viewed from the exterior side thereof, but at an opposing end thereof, and with focus on an upper region of the wall's height.

FIG. 5 is another end perspective view of the assembled exterior wall of FIG. 4, as viewed at the same end thereof, but from the interior side thereof with focus on a lower region of the wall's height.

FIG. 6 is another partial top perspective view of the assembled exterior wall of FIG. 3, but viewed from the interior side thereof at a mid-region of the wall's width.

FIG. 7 is an end perspective view of an assembled exterior wall of FIG. 1 constructed in accordance with a second embodiment of the invention, as viewed from an interior side thereof, with foam bodies of select insulation panels thereof omitted for illustrative purpose.

FIG. 8 is another perspective view of the assembled wall of FIG. 7 from the interior side thereof, and illustrating installation of electrical utility components therein.

FIG. 9 is another perspective view of the assembled wall of FIG. 8 from the interior side thereof with select components thereof partially cut away, and illustrating installation of interior drywall thereon.

FIG. 10 is a top perspective view illustrating attachment of the assembled wall of FIG. 8 to a neighbouring perpendicular wall of the same structure at an exterior corner of a building construction.

FIG. 11 is another perspective view of the assembled wall of FIG. 7 from the interior side thereof prior to the installation of the electrical wiring and drywall of FIGS. 8 and 9, and illustrating optional framing of a window opening in the wall.

### DETAILED DESCRIPTION

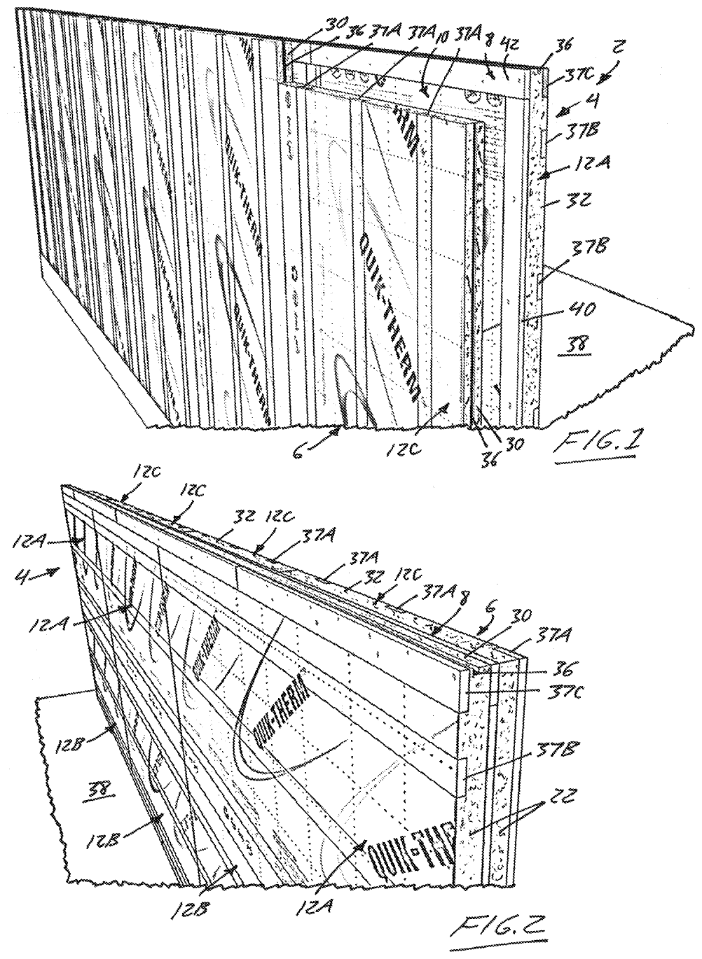

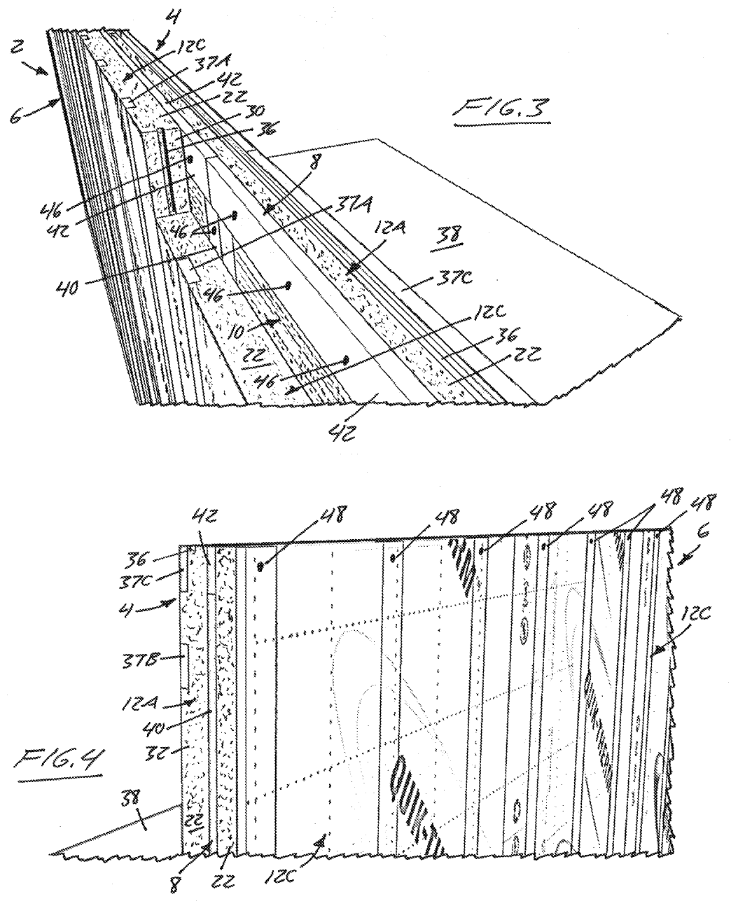

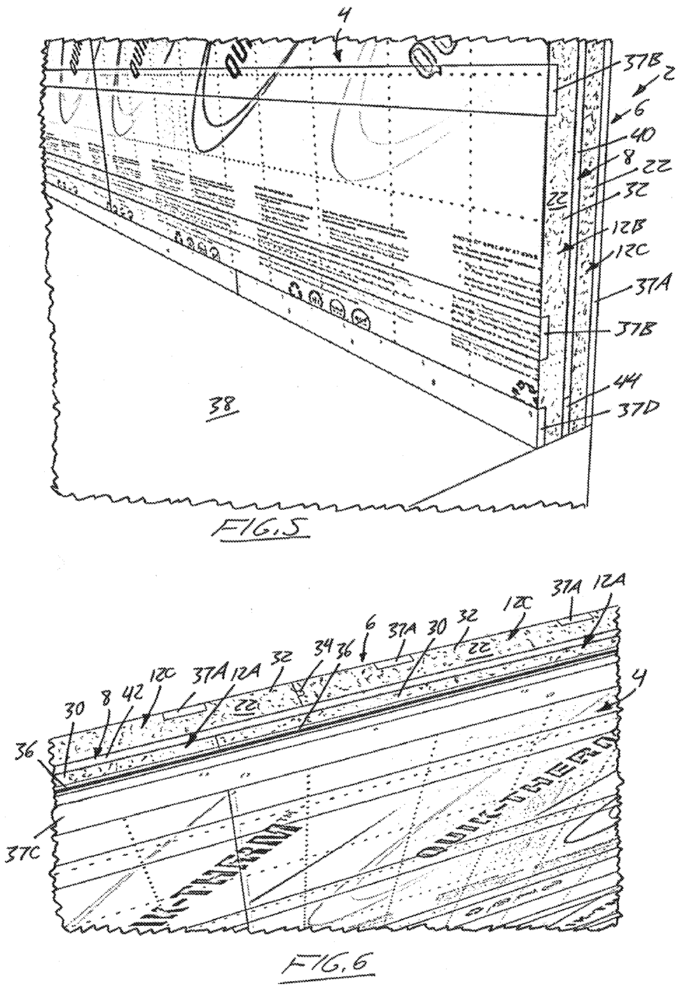

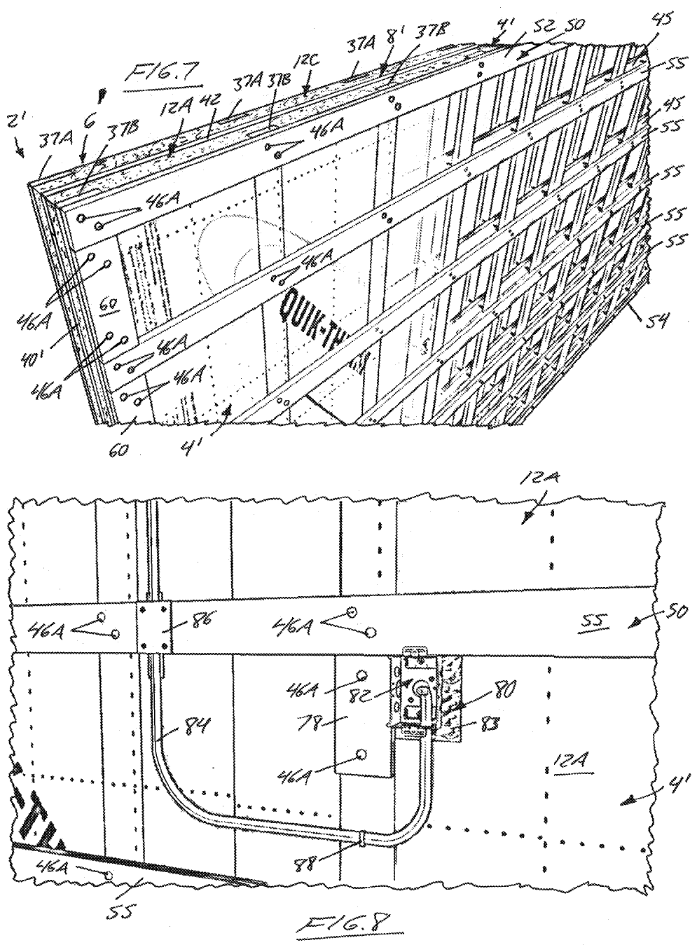

FIGS. 1 to 6 of the drawings illustrate a first embodiment of a novel exterior wall assembly 2 of the present invention, which employs a three-layer construction composed of an interior insulation layer 4 composed of rigid insulation panels, an opposing exterior insulation layer 6 also composed of rigid insulation panels, and an intermediate spacing layer 8 composed of a plurality of spacer boards sandwiched between the insulation panels of the two insulation layers 4, 6 and delimiting a plurality of air-filled, but otherwise unoccupied, void spaces 10 therebetween. The insulation panels of the interior insulation layer 4 are referred to herein as interior insulation panels 12A, 12B, and the insulation panels of the exterior insulation layer 6 are likewise referred to herein as exterior insulation panels 12C. When the expression “insulation panel” is used herein in generic fashion, unaccompanied by an “interior” or “exterior” qualifier, reference is being made to features that are common to both the interior and exterior insulation panels 12A-12C.

Each insulation panel 12A-12C is composed of the same general subcomponents, namely a foam core 22 of expanded polystyrene (EPS) or other foam material that is known to be suitable for rigid insulation panels, and two heat-reflective facers respectively applied to the foam core 22 at two opposing faces of the insulation panel. In the assembled and erected state of the wall, each face of each insulation panel 12A-12C faces either toward the interior space of the building, or away from the interior space of the building and toward the external environment outside the building. The heat-reflective facer on each face of each insulation panel 12A, 12B reflects radiant heat energy, thereby reducing heat transfer through the foam cores of the insulation panels 12A-12C to minimize heat transfer between the building's interior space and the external environment. Preferably, each laminated facer comprises a metalized polymer film laminated onto the foam core 22. The two faces of each insulation panel 12A-12C are rectangular in shape, and so the exterior of the foam core is composed of these two rectangular faces, plus four perimeter edges that span around the outer perimeters of the two rectangular faces. Each facer may be a uniformly intact and continuous span of material over the surface area of the respective face of the insulation panel, or may be a perforated sheet of the material having small pore-like holes or openings therein to increase the vapour permeability of the facer, as disclosed in Applicants issued U.S. Pat. No. 11,028,578, the entirety of which is incorporated herein by reference.

A length of each insulation panel, measured in one direction across each of its faces in any reference plane parallel to those faces, exceeds a width of the panel that is measured orthogonally of the length in the same plane. A thickness of each insulation panel between its two faces, as measured orthogonally of both the length and width thereof, is the smallest of the panel's three orthogonal dimensions. The four perimeter edges of each insulation panel include two lengthwise edges (one of which is labeled 30) of greater span than the two widthwise edges. Except where otherwise described, one lengthwise edge of each insulation panel features a male tongue 34 jutting outward therefrom over the full length of the panel from one widthwise edge 32 to the other. The other lengthwise edge 30 of each insulation panel features a female groove 36 recessed thereinto over the full length of the panel, whereby the tongue of one insulation panel is insertable into the groove of the next insulation panel to mate the insulation panels together via a tongue and groove interface at adjacent lengthwise edges of the two insulation panels. The exterior insulation panels 12C are oriented lengthwise-up in the assembled and erected state of the wall, whereby their lengthwise edges 30 stand vertically upright, while the interior insulation panels 12A-12B are installed widthwise-up, whereby their widthwise edges 32 stand vertically upright and their lengthwise edges run horizontally of the assembled and erected wall.

At discretely spaced intervals across the width dimension W of each insulation panel 12A-12C, a plurality of elongated rectangular battens are recessed into one of the two opposing faces of the panel's foam core. Each batten runs the full length of the insulation panel in perpendicular relation to the width thereof, thus spanning fully from one widthwise edge 32 of the insulation panel to the other. At least a subset of the battens of each insulation panel 12A-12C are embedded battens that are overlaid by the respective laminated facer and are evenly spaced from one another across the width of the insulation panel. In the illustrated embodiments, all of the battens of each exterior insulation panel 12C are embedded battens 37A covered by one of the panel's laminated facers, while all but one of the battens of each interior insulation panel 12A are embedded battens 37B covered by one of the panel's laminated facers.

In the illustrated embodiments, the length of each insulation panel is twice the width thereof, for example with each insulation panel measuring 4-feet wide and 8-feet long, and each insulation panel has three embedded battens space apart at 16-inch center-to-center intervals, with the outer two of the three embedded battens each being spaced 8-inches from the nearest lengthwise edge of the insulation panel to maintain the 16-inch batten spacing interval from one insulation panel to the next. The exterior insulation layer 6 is composed of a single row of exterior insulation panels 12C mated together side-by-side at their tongue-and-grooved lengthwise edges, while the interior insulation layer is composed of two rows of interior insulation panels, of which an upper row of interior insulation panels 12A resides atop a lower row of interior insulation panels 12B. In each row, the interior insulation panels 12A, 12B are abutted together at their widthwise edges 32. The lengthwise edges of the lower row of interior insulation panels mate via tongue and groove interface with the lengthwise edges of the upper row. In the illustrated embodiments, the interior insulation panels 12A, 12B are oriented groove-up/tongue-down, whereby the lengthwise tongues 34 of the upper row of interior insulation panels mate with the lengthwise grooves 36 of the lower row of interior insulation panels.

In this example where the interior insulation panels 12A, 12B are installed in a groove-up orientation, the tongues 34 of the bottom row of interior insulation panels are either cut off, or pre-emptively omitted in entirety during fabrication, so that the bottom lengthwise edges of the bottom row of interior insulation panels 12B can be seated flat against an underlying support surface (floor 38) atop which the assembled/erected wall stands in its finished state. Alternatively, the interior insulation panels 12A, 12B may be installed in tongue-up orientation, whereby the grooved bottom lengthwise edge of the bottom row of interior insulation panels can rest flat against the underlying support surface, and in which case the tongues of the upper row of interior insulation panels 12A may be either cut off, or pre-emptively omitted in entirety during fabrication, so that the top lengthwise perimeter edges of the top row of interior insulation panels are rendered tongueless. This way, the absence of a protruding tongue prevents interference with mounting of roof componentry atop the assembled and erected wall 2.

As shown in the example of the single-row exterior insulation layer 6 and double-row interior insulation layer 4 that are assembled from insulation panels of matching elongated size whose length is twice its length, the top widthwise edges 32 of the exterior insulation panels 12C reside flush with the top lengthwise edges 30 of the top row of interior insulation panels 12A, and thus lie in coplanar relation therewith at the top of the assembled and erected wall 2. Likewise, the bottom widthwise edges of the exterior insulation panels 12C reside flush with the bottom lengthwise edges of the bottom row of interior insulation panels 12B in coplanar relationship therewith to rest atop the underlying support surface 38 at the bottom of the assembled and erected wall 2. It will be appreciated that a wall whose targeted height is not evenly divisible by the insulation panel height and width may nonetheless be constructed, for example by trimming down prefabricated insulation panels of a standardized size to fulfill the targeted wall height. Likewise interior and exterior insulation panels at one or both ends of each row thereof can be trimmed down to meet a targeted overall width of the wall.

As mentioned earlier, all but one of the battens in each interior insulation panel 12A, 12B are embedded battens, referred to as such due their encapsulated state beneath the laminated facer that overlies the respective face of the foam core into which the battens are recessed. The face at which the embedded battens 37B are embedded in each interior insulation panel 12A, 12B is referred to herein an interior face thereof, because once the wall 2 is assembled and erected, this interior face of each interior insulation panel 12A, 12B faces inwardly toward the interior space of the building being constructed. In the drawings, the interior space of the building is recognizably denoted by included illustration of a horizontal floor 38 of the building's interior, at whose perimeter the assembled and erected wall 2 stands upright. The opposing face of each interior insulation panel 12A, 12B that faces outwardly away from the interior space of the building, and toward the external environment outside the building, is referred to herein as an outer face of the interior insulation panel 12A, 12B. To differentiate it from the embedded battens 37B, the singular remaining batten of each interior insulation panel that is not encapsulated under the laminated facer of the panel's interior face (the “interior facer”, for short), is instead referred to herein as an exposed batten.

In the top row of interior insulation panels 12A, the exposed batten 37C is an uppermost one of the panel's battens, and is recessed into the foam core at the top lengthwise edge 30 of the panel. This exposed uppermost batten 37C may be installed on the top row interior insulation panel 12A on-site during the assembly of the wall, in which case this exposed uppermost batten 37C is only secured to the foam core 22 of the interior insulation panel 12A during fastening of the interior insulation panel 12A to other wall components during the assembly process, which is described further below. In such instances where the exposed uppermost battens 37C are installed on-site during the wall assembly process, a plurality of batten boards installed end-to-end with one another to span the overall top row of interior insulation panels 12A and collectively form the exposed uppermost battens 37C thereof need not necessarily be installed in a one-to-one ratio with the quantity of panels 12A in that row, need not necessarily have individual lengths equal to those of the interior insulation panels, and thus need not each be aligned with a respective interior insulation panel 12A to span the particular individual length thereof.

In the bottom row of interior insulation panels 12B, each panel's exposed batten 37D is instead a lowermost one of the panel's battens, and is recessed into the foam core at the bottom lengthwise edge of the panel. The exposed lowermost battens 37D may be installed on the bottom row of interior insulation panels 12B on-site during the assembly of the wall 2, in which case this exposed lowermost batten 37D is only secured to the foam core 22 of the interior insulation panel 12B during fastening of the interior insulation panel 12B to other wall components during the wall assembly process, which is described further below. In such instance of on-site installation of the lowermost batten 37D, and just as described for the exposed uppermost battens 37C of the top row of interior insulation panels 12A, a plurality of batten boards installed end-to-end with one another to span the overall bottom row of interior insulation panels 12B to collectively form the exposed lowermost battens 37D thereof need not necessarily be installed in a one-to-one ratio with the quantity of panels 12B in that row, need not necessarily have individual lengths equal to those of the interior insulation panels, and thus need not each be aligned with a respective interior insulation panel 12B to span the particular individual length thereof.

In the first embodiment, where the exposed uppermost and lowermost battens 37C, 37D are installed on site, an uppermost strip of the interior face of each upper row interior insulation panel 12A, and a lowermost strip of the interior face of each lower row interior insulation panel 12B, are recessed relative to the rest of the interior insulation panel's interior face. In other embodiments, instead of providing an initially unoccupied and recessed strip at the interior face to accommodate on-site installation of an exposed batten 37C, 37D, the uppermost and lowermost battens 37C, 37D of the top and bottom row interior insulation panels 12A, 12B may be preinstalled at the time of factory production, and may optionally be overlaid by the laminated interior facer.

Turning attention to the exterior insulation panels 12C, the face of each exterior insulation panel 12C that faces toward the interior insulation panels 12A, 12B, and thus also faces toward the interior space of the building, is referred to as an inner face of the exterior insulation panel 12C. The opposing face of each exterior insulation panel 12C thus faces away from both the interior insulation panels 12A, 12B and the building's interior space, and faces toward the external environment, and is therefore referred to as the exterior face of the exterior insulation panel. The embedded battens 37A of the exterior insulation panels 12C are recessed into the foam cores 22 of the exterior insulation panels 12C at the exterior faces thereof, and are thus covered by the exterior laminated facers that overlie the foam cores of the exterior insulation panels at the exterior faces thereof.

All of the facers of both the interior and exterior insulation panels, or if not all of the facers, at least the interior and outer facers of the interior insulation panels 12A, 12B and the exterior facers of the interior insulation panels 12C, have printed indicia thereon marking the positions of the embedded battens 37A, 37B concealed beneath the facer, which enables visual identification of suitable fastening locations at which to fasten together the wall components during assembly of the wall 2, as described further below.

From the foregoing descriptions of the interior and exterior insulation panels, it will be appreciated that they are of notably similar composition and shape to one another, with the only difference being the incorporation of the additional (and optionally exposed) battens 37C, 37D on the interior insulation panels 12A, 12B, whether during factory production thereof or later on during on-site assembly. Accordingly, a manufacturer can optionally produce a volume of identical insulation panels according to the specifications of the described exterior insulation panels 12C, from which a subset of those identical insulation panels are then subjected to additional processing to cut away an uppermost or lowermost strip from the batten-equipped face each panel in the selected subset to thereby form an upper-row interior insulation panel 12A or lower-row interior insulation panel 12B for the interior insulation layer 4 of the assembled wall 2.

Having described the interior and exterior insulation panels used in the insulation layers of the wall, attention is now turned to the remaining intermediate layer that resides between the two insulation layers. The intermediate layer features a set of spacer boards, each of which may have width and thickness equal to those of the embedded battens 37A, 37B of the interior and exterior insulation panels 12A-12C, whose width and thickness in turn may also be equal to those of the exposed battens 37C, 37D. This way, the batten boards used for the embedded battens 37A, 37B and the exposed battens 37C, 37D share common dimensions with the spacer boards, thus enabling manufacturing efficiencies, where these different boards can be cut to size using the same cutting operations. In the illustrated embodiments, the batten boards and spacer boards of are plywood boards, though other board compositions, wooden or otherwise, may alternatively be used, provided they have sufficient strength and rigidity, which should exceed those of the foam cores of the insulation panels, as it is the batten and spacer boards that are used to fasten together the different layers of the wall and cooperatively impart sufficient structural integrity to the assembled and erected wall. In one non-limiting example, the batten and spacer boards measure 3-inches wide, and 0.75-inches thick.

The spacer boards are sandwiched between the outer face of the interior insulation panels 12A, 12B and the inner face of the exterior insulation panels 12C, and include upright spacer boards 40 that lie vertically in the assembled and erected state of the wall 2, and lateral spacer boards 42, 44 that lie horizontally in the assemble and erected state of the wall. The upright spacer boards 40 are installed at regularly spaced intervals across the width of the wall. The lateral spacer boards include header boards 42 that run along the top perimeter edges of the interior and exterior insulation panels 12A-12C at the top ends of the upright spacer boards 40, and footer boards 44 that run along the bottom perimeter edges of the interior and exterior insulation panels 12A-12C at the bottom ends of the upright spacer boards 40. In the illustrated example, the header boards 42 are abutted end-to-end to provide a continuous header spanning across the full width of the wall in uninterrupted fashion, and the footer boards 44 are likewise abutted end-to-end to provide a continuous footer spanning across the full width of the wall in uninterrupted fashion. The upright boards each fully span the distance between the header and footer, with a top end of each upright spacer board 40 terminating in in abutted relation against the bottom edge of the header, and a bottom end of each upright board terminating in abutted relation against a top edge of the footer.

The spacer boards 40-44 are fastened to the battens 37B-37D of the interior insulation panels 12A, 12B via a first set of fasteners 46 (e.g. framing nails) that penetrate through the spacer boards 40-44 from the exterior sides thereof that face the external environment, and onward through the foam cores 22 of the interior insulation panels 12A, 12B into the battens 37B-37D at the interior face thereof, but without penetrating through the interior face. This first set of fasteners 46 serves to secure the spacer boards to the interior insulation panels 12A, and thus is referred to herein as a set of interior fasteners 46. The interior fasteners 46 are used to fasten each header board 42 to the uppermost battens 37C of the top row of interior insulation panels 12A, to likewise fasten each footer board 44 to the lowermost battens 37D of the bottom row of interior insulation panels 12B, and to fasten each upright spacer board 40 to the remaining other battens 37B that reside between the uppermost and lowermost battens 37C, 37D.

The exterior insulation panels 12C are secured to the spacer boards 40-44 by a second set of fasteners 48, which is thus referred to herein as a set of exterior fasteners 48. The exterior fasteners 48 penetrate through the battens 37A of the exterior insulation panels 12C from the exterior faces thereof, and onward through the foam cores 22 of the exterior insulation panels 12C into the header and footer boards 42, 44 (and optionally into any intermediate lateral spacer boards, if included). The exterior fasteners 48 may penetrate fully through the header and footer boards 42, 44 for optimal fastening strength thereto, but are short enough so as to not fully penetrate the foam cores 22 of the interior insulation panels 12A, 12B, and to stop short of the uppermost and lowermost battens 37C, 27D of the interior insulation panels 12A, 12B to avoid thermal bridging across the assembled wall thickness. The exterior fasteners 48 are used to fasten the battens 37A of the exterior insulation panels 12C to the header and footer boards 42, 44 of the intermediate layer 8. The interior and exterior insulation layers 4, 6 are thereby indirectly fastened together via the fastening of their respective battens to the spacer boards 40-44 of the intermediate layer 8.

The spacer boards 40-44 set the interior and exterior insulation panels apart from one another by a gap distance equal to the thickness of the spacer boards. The thickness of each spacer board is the shortest of its three orthogonal dimensions, of which its length is the greatest. The two broad faces of each spacer board, whose surfaces areas are the product of the board's length and width, lie parallel to the faces of the insulation panels 12A-12C, and thus face inwardly toward the building's interior space and outwardly away therefrom toward the external environment. This is of contrary relation to the stud orientation in a conventionally framed wall, where the narrower edges (not the broader faces) of the wall studs face the building interior and external environment. With the flat outer faces of the interior insulation panels 12A, 12B being spaced apart from the flat inner faces of the exterior insulation panels 12C by the thickness of the spacer boards 40-42, a plurality of air-filled but otherwise unoccupied void spaces 10 are delimited between the interior and exterior insulation panels. Each such void space 10 is bound on two sides by an adjacent pair of the upright spacer boards 40, and bound at the top and bottom by the header and footer boards 42, 44 that span between the adjacent pair upright spacer boards 40.

Unlike the stud cavities of a conventionally framed exterior wall, which are typically filled with batt insulation, these void spaces 10 in the inventive wall 2 are left empty of any insulation material or other non-gaseous substance, and therefore contain only air, and thus serve as heat-insulative air cavities. In the illustrated embodiments, where the outer faces of the interior insulation panels 12A, 12B and the inner faces of exterior insulation panels 12C are each laminated with a heat-reflective facer, the thermally insulative performance of these void spaces 10 between the two insulation layers 4, 6 is believed to be particularly effective. With two insulation layers 4, 6, unoccupied void spaces 10 delimited therebetween in an intermediate layer 8, and heat-reflective facers that not only reflect thermal energy but also mitigate vapour permeation through the insulation layers, a thermally effective and moisture mitigating wall structure 2 is achieved. The wall 2 is easy to assemble using only prefabricated insulation panels 12A-12C and relatively thin boards that can be easily and efficiently transported as a flat-pack kit, without the need for the vapour barrier sheeting or batt insulation of conventionally framed wall constructions. The battens 37A of the exterior insulation panels 12A enable subsequent fastening of any variety of external cladding to the assembled and erected wall 2 at the building exterior, just as the battens 37B-37D of the interior insulation panels 12A, 12B enable subsequent fastening of interior wall finishes (drywall, paneling) within the building interior, along with fastening of such finishing trim as baseboards, moulding, etc. to the uppermost and lowermost battens 37C, 37D of the interior insulation panels 12A, 12B.

Having described the finished structure of the assembled and erected wall 2, attention is now turned to a preferred process for assembling the wall components. Firstly, the two rows of interior insulation panels 12A, 12B are laid out edge-to-edge with one another atop the floor 38 or other horizontal support surface, with the interior faces of these panels 12A, 12B facing downward, and with the tongues and grooves of the two rows of panels 12A, 12B mated together, and preferably secured in such mated condition with tape, spray foam, adhesive or other suitable securement agent. If the uppermost and lowermost 37C, 37D battens of the interior insulation panels 12A, 12B have not been pre-installed, they are now placed beneath the laid-out top and bottom rows of interior insulation panels 12A, 12B in the recessed strips at the top and bottom edges thereof, respectively. Next, the spacer boards 40-44 are laid atop the already laid-out interior insulation panels 12A, 12B, with the header boards 42 running along the top edges of the top row of insulation panels 12A, the footer boards 44 running along the bottom edges of the bottom row of insulation panels 12B, and the upright spacer boards 40 spanning perpendicularly between the header boards 42 and footer boards 44. The laid-out spacer boards 40-44 are then fastened in place by driving the interior fasteners 46 downwardly through the spacer boards 40-44 and into the battens 37B-37D of the underlying interior insulation panels 12A, 12B, without penetrating fully therethrough into the floor 38, owing to the appropriately selected length of interior fastener 46.

Next, the exterior insulation panels 12C are laid out side-by-side in a singular row atop the spacer boards 40-44 and the underlying interior insulation panels 12A, 12B to which the spacer boards have been fastened. The exterior insulation panels 12C are laid out with their exterior faces facing upwardly, with their battens 37A lying perpendicularly to the battens 37B-37D of the interior insulation panels 12A, 12B, and with their tongues and grooves 34, 36 mated together at their abutting lengthwise edges. The laid-out exterior insulation panels 12C are then fastened in place by driving the exterior fasteners 48 downwardly through the battens 37A of the exterior insulation panels 12C and into the lateral spacer boards 42, 44 already fastened atop the underlying interior insulation panels 12A, 12B, once again without penetrating fully through the foam cores 22 thereof, owing to the appropriately selected length of exterior fastener 48.

Having fastened the spacer boards 40-44 to the interior insulation panels 12A, 12B, then fastened the exterior insulation panels 12C to a subset of the spacer boards, the interior and exterior insulation panels 12A-12C and spacer boards 40-44 are now all secured together into an assembled unit, which can then be erected into an upright position standing atop the floor 38. The assembled unit 10 is then appropriately positioned at a perimeter boundary of the floor 38, such that the interior faces of the interior insulation panels 12A, 12B face horizontally inward over the floor 38 of the building interior, and the exterior faces of the exterior insulation panels 12C face horizontally outward from the interior floor 38 toward the external environment. After having stood the assembled unit upright, additional interior and/or exterior fasteners 46, 48 can be added to further increase the structural rigidity of the assembled and erected wall 2.

FIGS. 7 to 11 illustrate a second embodiment of the novel exterior wall assembly 2′, which again features interior and exterior insulation layers 4′, 6 both composed of insulation panels of same type described above for the first embodiment, and an intermediate spacing layer 8′ once again composed of spacer boards sandwiched between the two insulation layers 4′, 6 to once again bound air-filled voids therebetween in similar manner to those of the first embodiment. To these three layers, the second embodiment wall adds an interior spacing layer 50 likewise composed of spacer boards fastened to the embedded battens of the interior insulation layer 4′, but installed at the interior face thereof rather than the outer face thereof. In this embodiment, the interior spacing layer 50 enables mounting of the drywall or other interior finishing material over the interior face of the wall at a short distance offset inwardly therefrom by the spacer boards of the interior spacing layer 50, thereby creating additional air-filled voids between the drywall and the interior insulation panels. These additional voids on the interior side of the interior insulation panels can be used to accommodate installation of electrical or other utilities, while also creating a second array of heat-insulative air cavities at the interior faces of the interior insulation panels to supplement the first array of heat-insulative air cavities at the outer faces thereof, thus increasing the overall insulative value of the finished wall assembly.

Before turning to the details of the added interior spacing layer 50, the second embodiment is first used to a describe a few details among the insulation layers and intermediate spacing layer 8′ thereof that offer alternatives to those described above for the first embodiment. Unlike the first embodiment, where the internal insulation panels 12A, 12B were laid out widthwise-up in perpendicular relation to the lengthwise-up orientation of the exterior insulation panels 12C, with the result that the embedded battens 37A, 37B of the two insulation layers are of orthogonal relationship to one another, the second embodiment instead has the internal and external insulation panels placed in the same lengthwise-up orientation as one another, whereby the embedded battens 37A, 37B of the two insulation layers are laid out parallel to one another, and optionally in alignment with one another. In the second embodiment, all of the interior insulation panels are therefore labelled simply as 12A, given that there is only a singular row of such panels in this embodiment, without the accompanying second row 12B that was included in the multi-rowed instance of the first embodiment.

Another difference in the second embodiment is the inclusion of a greater quantity of lateral spacer boards in the intermediate spacing layer 8′, where in addition to the header boards 42 running along the top perimeter edges of the interior and exterior insulation panels 12A, 12B and the footer boards 44 running along the bottom perimeter edges of the interior and exterior insulation panels 12A, 12C, there are a plurality of intermediate lateral spacer boards 45 distributed in parallel relation to, and at regularly spaced intervals between, the header and footer boards 42, 44. In accompaniment to this change, at least at each end of the assembled wall, a set of upright spacer boards 40′ of individually shorter length than the longer upright spacer boards 40 of the first embodiment are included. Each such upright spacer board 40′ spans the vertical distance between a respective neighbouring pair of the lateral spacer boards 42, 44, 45, instead of spanning the longer full distance between the header and footer boards 42, 44 like the longer upright spacer boards 40 of the first embodiment. So, in the first embodiment, each void space 10 in the intermediate spacing layer 8 was a rather tall cavity spanning the entire vertical distance between the header and footer boards 42, 44, and spanning the horizontal distance between two full-length upright-spacer boards 40. In the second embodiment, each void space 10A in the intermediate spacing layer 8 is a horizontally elongated and vertically narrower cavity spanning the vertical distance between an adjacent pair of the larger quantity of lateral spacer boards 42, 44, 45, and the horizontal distance from one set of upright spacer boards 40′ to another, for example from one end of the wall to the other. That said, additional sets of upright spacer boards 40′ may optionally be installed at periodic intervals along the overall wall width, like the taller upright spacer boards 40 of the first embodiment.

Turning now to the second embodiment's interior spacing layer 50, it is of the same construction of the second embodiment's intermediate spacing layer 8 described in the preceding paragraph, thus having header boards 52 running along the top perimeter edges of the interior insulation panels 12A; footer boards 54 running along the bottom perimeter edges of the interior insulation panels 12A; a plurality of intermediate lateral spacer boards 55 distributed in parallel relation to, and at regularly spaced intervals between, the header and footer boards 52, 54; and, at least at each end of the wall 2′, a set of upright spacer boards 60 each spanning the vertical distance between a respective neighbouring pair of the lateral spacer boards 52, 54, 55. Since the embedded battens 37B of the interior insulation panels 12A of the second embodiment are vertically oriented, not horizontally oriented like those of the first embodiment, the header and footer boards 52, 54 of the interior spacer layer 50 effectively replace the exposed uppermost and lowermost battens 37C, 37D when it comes to fastening of finishing trim (baseboards, moulding) to the drywalled or otherwise finished wall interior at the end of the installation process.

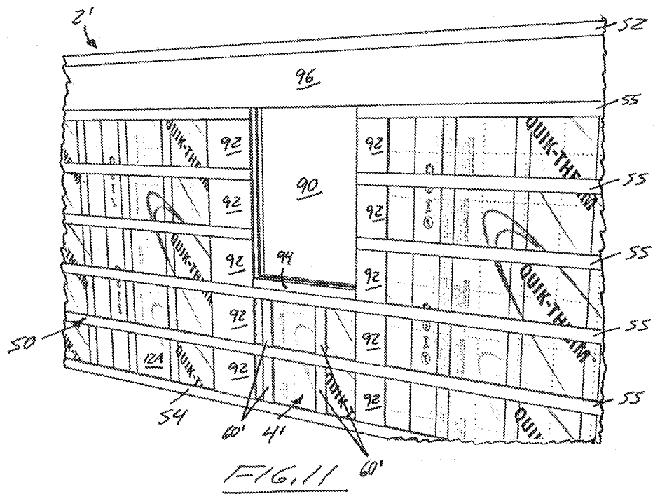

Like in the first embodiment, a set of interior fasteners 46 (see FIG. 10) for fastening the intermediate layer's spacer boards 40′, 42, 44, 45 to the interior insulation panels penetrate through the spacer boards 40′, 42, 44, 45 from the exterior sides thereof that face the external environment, and onward through the foam cores 22 of the interior insulation panels 12A into the battens 37B at the interior face thereof, but without penetrating through the interior face. Since these fasteners 46 must be shallow enough to only partially penetrate the embedded battens 37B, further securement of the intermediate layer's spacer boards 40′, 42, 44, 45 may be provided by a supplemental second set of interior fasteners 46′ (e.g. framing nails) that are be driven through the embedded battens 37B of the interior insulation panels 12A from the interior faces thereof (i.e. in the opposite direction from the first set of interior fasteners 46), and onward through the foam cores 22 of the interior insulation panels 12A into or through the lateral spacer boards 42, 44, 45 of the intermediate spacing layer 8′ (and optionally also into or through the upright spacer boards 40′ thereof anywhere a subset of the embedded battens 37B align therewith), but without penetrating fully through the foam cores 22 of the exterior insulation panels 12C nor into the embedded battens 37A thereof, thereby avoiding thermal bridging across the full assembled wall thickness.

The second embodiment includes yet another set of fasteners 46A (e.g. framing nails) driven through the embedded battens 37B of the interior insulation panels 12A, this time for the purpose of holding the spacer boards of the interior spacing layer 50. At least a subset of these interior spacer fasteners 46A are driven through the lateral spacer boards 52, 54, 55 of the interior spacing layer 50 from an interior side thereof, onward through the embedded battens 37B of the interior insulation panels 12A, and further onward through the foam cores 22 thereof into or through the lateral spacer boards 42, 44, 45 of the intermediate spacing layer 8′, which reside in alignment with the lateral spacer boards 52, 54, 55 of the interior spacing layer 50, but without penetrating fully through the foam cores 22 of the exterior insulation panels 12C, nor into the embedded battens 37A thereof, thereby again avoiding thermal bridging across the full wall thickness. Another subset of these interior spacer fasteners 46A may penetrate the lateral spacer boards 52, 54, 55 of the interior spacing layer 50 into the lateral spacer boards 42, 44, 45 of the intermediate spacing layer 8′ at locations between, and thus not penetrating, the embedded battens 37B of the interior insulation panels 12C. Another subset of the interior spacer fasteners 46A may be driven through the upright spacer boards 60 of the interior spacing layer 50 from the interior side thereof, onward through the embedded battens 37B of the interior insulation panels 12A, and further onward through the foam cores 22 thereof into or through the upright spacer boards 40′ of the intermediate spacing layer 8′, which reside in alignment with the upright spacer boards 60 of the interior spacing layer 50 at the ends of the wall, again without penetrating fully through the foam cores 22 of the exterior insulation panels 12C, nor into the embedded battens 37A thereof, to avoid thermal bridging across the full wall thickness.

The exterior fasteners 48 in the second embodiment are driven in matching fashion to the first embodiment, i.e. through the embedded battens 37A of the exterior insulation panels 12C from the exterior faces thereof, onward through the foams cores 22 of the exterior insulation panels 12C, and into or through the lateral spacer boards 42, 44, 45 of the intermediate spacing layer 8′ (and optionally also into or through the upright spacer boards 40′ thereof anywhere a subset of the embedded battens 37A align therewith), but without penetrating fully through the foam cores 22 of the interior insulation panels 12A, nor into the embedded battens 37B thereof, again to avoid thermal bridging across the full wall thickness.

FIG. 10 illustrates joining of two neighbouring walls of the second embodiment where they meet together in perpendicular relationship to one another at an exterior corner of a building. At the end of one these walls, the last embedded batten of the respective exterior insulation panel 12C has been removed, and in its place has been substituted a wider fastening batten 62 of greater width than, but equal thickness to, the formerly embedded batten, now removed. The width of this fastening batten 62 reaches beyond the upstanding lengthwise end of the respective exterior insulation panel 12C, by a projecting distance approximately equal to the thickness of the neighbouring wall, whose upstanding end is abutted up against the projecting portion of the fastening batten 62. To the exterior insulation panel 12C whose removed batten was replaced with the fastening batten 62, the fastening batten 62 is fastened by a subset of that wall's exterior fasteners 48, driven straight through the fastening batten 62 from the exterior side thereof into the spacer boards 42, 44, 45, 60 of the intermediate spacing layer 8′ of that same wall. As also shown in FIG. 10, a first set of angled exterior corner fasteners 64A (e.g. framing nails), at spaced elevations along the fastening batten 62, may also be driven through the fastening batten 62 from the exterior side thereof and into or through the nearest embedded batten 37B of the interior insulation layer 4′ of the neighbouring wall. For brevity, the embedded battens 37B of the interior insulation layer of either wall may be referred to as the interior battens thereof, just as the embedded battens of the exterior insulation layer of either wall may be referred to as the exterior battens thereof. As also shown, a second set of angled exterior corner fasteners 64B (e.g. framing nails), again at spaced elevations along the fastening batten 62, may also be driven through the fastening batten 62 from the exterior side thereof and into or through the upright and/or lateral spacer boards 40, 42, 44, 45 of the intermediate spacing layer 8′ of the neighbouring wall.

Aside from such angled exterior corner fasteners 64A, 64B, the fastening batten 62 may be fastened straight on, again at spaced elevations therealong, to the nearest interior batten 37B of the neighbouring wall by a first set of smaller non-angled exterior corner fasteners 66A driven straight into that nearest interior batten 37B at the upright narrow edge thereof abutted by the inner side of the fastening batten 62. Likewise, the fastening batten 62 may be fastened straight on, again at spaced elevations therealong, to the nearest exterior batten 37A of the neighbouring wall by a second set of such non-angled exterior corner fasteners 66B driven straight into that nearest exterior batten at the upright narrow edge thereof abutted by the inner side of the fastening batten 62. Any subset of these four contemplated exterior fasteners 64A, 64B, 66A, 66B that are of collectively capable of sufficient structural strength may be employed in the alternative to the illustrated combination of all four types.

Turning away from the exteriorly located fastening batten 62, but still referring to FIG. 10, further securement of the two neighbouring wall assemblies to one another is achieved at the interior side of their corner intersection by a set of angled interior corner fasteners (e.g. framing nails) 68 driven through the interior batten 37B that resides across from the exterior fastening batten 62 on the same wall assembly thereas, and into the nearest interior batten 37B of the other wall (i.e. the same interior batten 37B to which the exterior fastening batten 62 is fastened by angled exterior corner fasteners 64A).

As shown in FIG. 9, drywall sheets 70 or other interior finishing panels are fastened to the lateral spacer boards 52, 54, 55 (and optionally also to the upright spacer boards 60) of the interior spacing layer 50 of the assembled and erected wall 2′ using suitable fasteners 72 (e.g. drywall screws), which may be referred to herein as finishing fasteners to distinguish them from the interior and exterior fasteners 46, 46′, 46A, 48, 64A, 64B, 66A, 66B (e.g. nails, typically) used in the earlier wall assembly stages. Fastening of the drywall 70 indirectly to the interior insulation panels 12A via the spacer boards 52, 54, 55, 60 of the interior spacing layer 50 results in a horizontal offsetting of the drywall 70 a short distance from the interior faces of the interior insulation panels 12A to create insulative air-filled voids therebetween, just in the same way that the spacer boards 40, 42, 44, 45 of the intermediate spacing layer 8′ horizontally offset the two insulation layers from one another to also create such insulative air-filled voids therebetween. Whereas the finished wall of the first embodiment has only a singular array of such insulative air-filled voids, specifically located between the two insulation layers 4, 6 and bound by the spacer boards 40, 42, 44 of the intermediate spacing layer 8, the second embodiment has two arrays of insulative air-filled voids: a first array of insulative air-filled voids 10A located between the two insulation layers 4′, 6 and bound by the spacer boards 40′, 42, 44, 45 of the intermediate spacing layer 8′, and a second array of insulative air-filled voids 10B located between the interior insulation layer 4′ and the installed finishing layer (e.g. drywall 70) and bound by the spacer boards 52, 54, 55, 60 of the interior spacing layer 50.

Still referring to FIG. 9, a bead of spray foam 76 or other suitable air-tight sealant is preferably run along the inside of edge of any and all spacer boards 40, 42, 44 of the intermediate spacing layer 8′ that reside at outer perimeter edges of the wall assembly, thus ensuring that the first array of insulative air-filled voids 10A are sealed in air-tight fashion from the external environment. One such bead of spray foam 76 is shown running along the bottom edge of the header board 42 of the FIG. 9 wall 2′, and such beads may are likewise along the top edge of the footer board 44, and the inside edge of every upright spacer board 40′ at each end of the assembled wall. Air-tight isolation of the different insulative air-filled voids of the array is not essential, hence the illustrated omission of such spray foam or other sealant beads along the intermediate lateral board 45 of FIG. 9, though inclusion of such additional sealant beads is still within the contemplated scope of the invention.

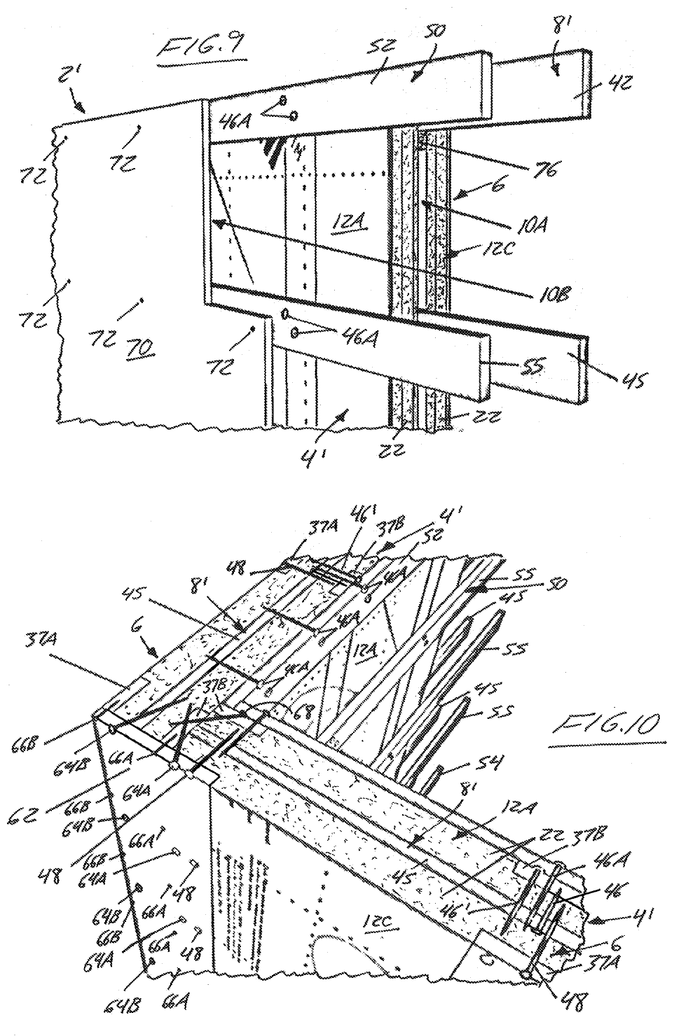

Turning back to FIG. 8, before the installation of the drywall 70 or other finishing of FIG. 9, electrical wiring or other in-wall utilities may optionally be installed, taking advantage of available utility routing space denoted by the air-filled but otherwise unoccupied void spaces 10B of the interior spacing layer 50. The figure shows a utility mounting board 78, whose thickness is equal, or at least no greater, than that of the spacer boards 52, 54, 55, 60 of the interior spacing layer 50, having been fastened in place to the interior face of one of the interior insulation panels 12A an aligned relation over one of the embedded battens 37B thereof, for example at a location of abutting adjacency to a horizontal lengthwise edge of one of the intermediate lateral spacer boards 55, for example using the same type of interior fasteners 46A by which the spacer boards 52, 54, 55, 60 are mounted to the interior insulation panels 12A. A small mounting cavity 80 is cut into the interior face of the interior insulation panel 12A beside this mounting block 78, to a sufficient depth accommodating placement of a conventional electrical box 82 in a suitable mounting position that will place the open front of the electrical box generally flush with the interior surface of the drywall 70, thus compensating for the face that a conventional electrical box will have a depth exceeding the thickness of the typical spacer board thickness.

The electrical box 82 is fastened to the upright side edge of the mounting board 78 that neighbours this mounting cavity 80, which may then be filled with a spray foam 83 in order to fill any excess space of the cavity 80 not occupied by the mounted electrical box 78. Routing of electrical wiring 84 to the electrical box 78 from an electrical panel, fixture or other electrical box can be accommodated by cutting of a recessed notch or break into one or more of the spacer boards 52, 54, 55, 60. As shown in the illustrated example at the higher of the two visible lateral spacer boards 55, any such wire-accommodating notch or break cut into the spacer board 55 may optionally be covered by a metallic or otherwise puncture-proof/resistant protection plate 86 that is affixed to the gapped or notched lateral board 55 to overlie the break or notch therein and protect the electrical wiring running therethrough. The routed wiring 84 can be anchored to the wall assembly 2′ at any location overlying any one of the embedded battens 37B of the interior insulation panels 12A, as demonstrated by the electrical wiring staple 88 fastened to the same embedded batten 37B as the mounting board 78 in the illustrated example. In addition or alternative to such electrical wiring, similar routing of other utilities (plumbing, television/internet/phone cables, speaker wire, etc.) within the voids 10B of the interior spacing layer 50 is also possible within the novel wall assembly 2′ of the second embodiment.

FIG. 11 illustrates framing of a window opening 90 in the novel wall assembly 2′ of the second embodiment. The window opening 90 is cut through all four layers 4′, 6, 8′, 50 of the assembled wall 2′ at the intended window location, and a respective set of upright framing boards 92 of equal thickness to the spacer boards 52, 54, 55, 60 of the interior spacing layer 50 are added to this layer on each side of the window opening 90, with each framing board 92 spanning the vertical distance between a respective adjacent pair of the lateral spacer boards 52, 54, 55. In this way, the framing boards 92 are installed in the same fashion as the upright spacer boards 60 at the ends of the wall 2′, and are fastened to the two embedded battens 37B of the interior insulation layer 4′ nearest to the window opening 90 on opposite sides thereof. Where the framing boards 92 may differ from the upright spacer boards 60 is that they may have a greater width, to whatever degree such extra width is necessary to ensure that each framing board 92 overlaps with the nearest embedded batten 37B on the respective side of the window opening 90.

Beneath the window opening, additional upright spacer boards 60′ are installed between adjacent pairs of the lateral spacer boards 54, 55 below the window opening 90 in aligned relation over any embedded battens 37B that intersect the bottom boundary of the window opening 90, of which there are two such intersecting interior battens 37B in the illustrated example. Unless the bottom boundary of the window opening 90 coincides with one of the intermediate lateral spacer boards 55, a lower lateral filler board 94 of equal thickness to the spacer and framing boards is installed along the bottom boundary of the window opening 90, with the filler board's length spanning between the two sets of framing boards 92, and the lower lateral filler board's vertical width spanning from the bottom boundary of the window opening 90 to the top edge of the nearest lateral spacer board 55 beneath the window opening 90. This lower lateral filler board 94 is fastened to the embedded interior battens 37B that intersect the bottom boundary of the window.

Likewise, an upper lateral filler board 96 of equal thickness to the spacer and framing boards is installed along the top boundary of the window opening 90, with this filler board's vertical width spanning from the top boundary of the window opening 90 to the bottom edge of the next lateral spacer board above the window opening 90, which in the illustrated example is the header board 52 of the interior spacing layer 50. In the illustrated example, the top boundary of the window opening 50 coincides with the top edges of the highest one of the intermediate lateral spacer boards 55, and the upper lateral filler board 96 extends horizontally beyond the vertical side boundaries of the window opening 90, and on each side of the window opening 90, fills the space from the top edge of the highest intermediate lateral spacer board 55 to the bottom edge of the header board 52, thus omitting the need for the smaller framing boards 92 between the header board 52 and the highest intermediate lateral spacer board 55. In the illustrated but non-limiting example, this upper lateral filler board 96 spans the full width of the wall 2′ from one end thereof to the other, whereby the header board 52, upper lateral filler board 96 and highest one of the intermediate lateral spacer boards 55 cooperatively form a combined header that is of greater height and robustness than the smaller header board 52 alone, and spans the entire width of the wall 2′, and not just the isolated area thereof above the window opening 90. This filler board 96 is fastened to all of the embedded interior battens 37B that it crosses over, which in the illustrated example spanning the entire width of the wall, encompasses all of the wall's embedded interior battens 37B.

The same framing of the window opening with framing boards 92, filler boards 94, 96 and additional upright spacers 60′ shown at the interior spacing layer 50 is also done within the intermediate spacer layer 8′, though illustration of such framing in the intermediate layer is not separately illustrated to avoid unnecessary duplication. In some embodiments, such window framing in the intermediate layer alone may be structurally sufficient, though it is anticipated that the window framing would typically be done within both spacing layers 8′, 50 for optimal structural integrity. While the illustrated example is a window opening 90, it will be appreciated that a door opening can be framed in similar fashion, with a respective set of framing boards 92 on each side of the door opening and the upper filler board 96 above the door opening, but without the lower filler and upright spacer boards 94, 60′ given the greater height of the door opening, which will span all the way down to the footer board 54.

The assembly process for the second embodiment wall 2′ includes substantial duplication of the assembly process described above for the first embodiment, followed by installation of the interior spacer layer 50 after erection of the assembled insulation panels and intermediate layer spacer boards. So, first the interior insulation panels are laid out in mated relation to one another batten side down (i.e. interior face down), this time in a singular row, and the interior spacer boards 40′, 42, 44, 45 are laid out top the upward facing outer faces of the laid-out interior insulation panels, and fastened in place with the interior fasteners 46. Next, the exterior insulation panels 12C are laid out batten side up (i.e. exterior face up) in mated side-by-side relation, again preferably secured together via any of the aforementioned securement agents, in a singular row atop the spacer boards 40′, 42, 44, 45 and the underlying interior insulation panels 12A to which the spacer boards 40′, 42, 44, 45 have been fastened. The laid-out exterior insulation panels 12C are then fastened in place by driving the exterior fasteners 48 downwardly through the battens 37A of the exterior insulation panels 12C and into the spacer boards 40′, 42, 44, 45 already fastened atop the underlying interior insulation panels 12A.

The assembled unit is then erected, whereupon the second set of interior fasteners 46′ are driven into the interior battens 37B to strengthen the fastened interconnection between the interior battens 37B and the spacer boards of the intermediate layer 8′. The interior spacer boards 52, 54, 55, 60 are then fastened to the interior insulation panels 12C at the interior faces thereof using the interior spacer fasteners 46A. Multiple walls assembled in this fashion can then be erected, and then secured together in neighbouring pairs at corners of the building being constructed using the fastening batten 62 described above. Exterior cladding can then be fastened to the embedded battens 37A of the exterior insulation panels 12C at the exterior faces thereof, and electrical or other utilities installed in the interior spacing layer 50, followed by drywall or other interior finishing. For any walls with window or door openings, the described framing thereof in the intermediate spacing layer is done amid the wall assembly process, during the installation of the intermediate spacing layer atop the laid down interior insulation panels, prior to the addition of the exterior insulation panels onto to the installed spacer board. So the door/window opening can be precut into the interior insulation panel(s) (whether on-site, or beforehand) before installation of the intermediate layer spacer boards thereon, so that the laying out of such boards includes the described framing of this door/window opening, over which the exterior insulation panel(s) is/are then laid, whether with a matching precut opening therein, or without such an opening, the cutting of may instead be left for a later post-erection cutting thereof, using the existing opening in the interior insulation panel(s) and the intermediate spacing layer framing (and the interior spacing layer framing, if included, and already installed) as a cutting guide for the door/window opening in the exterior insulation panel(s).

The entire wall assembly 2′ of the second embodiment can be assembled on site with simply a standard framing nailer, the various boards (e.g. 0.75-inch plywood, many of which may be precut and supplied with the insulative panels) and commercially available spray foam, without need for any batt insulation, polymeric vapour barrier sheeting, exterior house wrap, or exterior sheathing. As with the first embodiment, exterior cladding is installed directly onto the exterior faces of the exterior insulation panels 12C, being fastened to the embedded battens 37A thereof over most of the wall area, and to the fastening battens 62 at any corners of the building where two neighbouring walls intersect at a right angle and are joined by such a fastening batten 62. The addition of the second array of thermally insulative air-filled voids 10B by the interior spacer layer 50 of the second embodiment may increase the effective R-value of the wall by about R-3, compared to the first embodiment, with the added benefit that these voids 10B of the interior spacing layer 50 enable easily installation and routing of electrical and/or other utilities within the wall, before final installation of the drywall or other interior finishing.

In one non-limiting example, the insulation panels may be 2-inches thick, with which 0.75-inch plywood boards results in an overall assembled wall thickness of 5.5-inches (excluding exterior cladding and interior drywall). Alternatively, use of 2.5-inch thick insulation panels is believed capable of an estimated R-value of approximately R30, with a modestly increased wall thickness of 6.5-inches. Based on prototyping, construction knowledge and research, it is estimated that with just two labourers, a 40-foot wall can be assembled and erected in less than 2-hours, ready for installation of windows, doors, exterior cladding and interior drywall.

Since various modifications can be made in my invention as herein above described, and many apparently widely different embodiments of same made, it is intended that all matter contained in the accompanying specification shall be interpreted as illustrative only and not in a limiting sense.

1. A wall assembly comprising:
interior and exterior insulation layers that respectively comprise interior insulation panels and exterior insulation panels, of which both said interior insulation panels and said exterior insulations each have a foam core, two opposing faces, and plurality of perimeter edges, of which the two opposing faces of each interior insulation panel comprise an interior face that faces away from the exterior insulation layer and an outer face that faces toward the exterior insulation layer, while the two opposing faces of each exterior insulation panel comprise an exterior face that faces away from the interior insulation layer and an inner face that faces toward the interior insulation layer;
laminated onto the foam core of each of the interior insulation panels and the exterior insulation panels, at least one laminated facer respectively occupying at least one of the two opposing faces thereof;
a set of interior battens recessed into the foam cores of the interior insulation panels at the interior faces thereof;
a set of exterior battens recessed into the foam cores of the exterior insulation panels at the exterior faces thereof;
a set of spacer boards installed in an intermediate layer between the interior and exterior insulation layers;
a set of interior fasteners by which the interior battens and the spacer boards are interconnected; and
a set of exterior fasteners by which the exterior battens and the spacer boards are interconnected.

2. The wall assembly of claim 1 wherein, on each of the interior insulation panels, said at least one laminated facer comprises an outer facer occupying the outer face of the interior insulation panel.

3. The wall assembly of claim 1 wherein, on each of the exterior insulation panels, said at least one laminated facer comprises an inner facer occupying the inner face of the exterior insulation panel.

4. The wall assembly of claim 1 wherein, on each of the interior insulation panels, said at least one laminated facer comprises two laminated facers, including an interior facer occupying the interior face of the interior insulation panel.

5. The wall assembly of claim 1 wherein, on each of the exterior insulation panels, said at least one laminated facer comprises two laminated facers, including an exterior facer occupying the exterior face of the interior insulation panel.

6. The wall assembly of claim 1 wherein a thickness of each spacer board, in a direction in which said spacer boards separate the interior and exterior insulation panels from one another, is lesser than both a width and length of the spacer board.

7. The wall assembly of claim 6 wherein said thickness of each spacer board is no greater than 1-inch.

8. The wall assembly of claim 1 wherein the spacer boards comprise plywood boards.

9. The wall assembly of claim 1 wherein the spacer boards and at least one of either the interior battens and the exterior battens are of a same composition as one another.

10. The wall assembly of claim 9 wherein the spacer boards, the interior battens and the exterior battens are all of said same composition as one another.

11. The wall assembly of claim 1 wherein the spacer boards and at least one of either the interior battens and the exterior battens are equal to another in at least one of either width and thickness.

12. The wall assembly of claim 1 wherein the interior battens of each interior insulation panel comprise embedded interior battens overlain by one of the at least one laminated facer of said interior insulation panel.

13. The wall assembly of claim 1 wherein the exterior battens of each exterior insulation panel comprise embedded exterior battens overlain by one of the at least one laminated facers of said exterior insulation panel.

14. The wall assembly of claim 1 further comprising a set of additional spacer boards installed on the interior face of the interior insulation panels to accept indirect mounting of interior finishings onto the interior insulation panels in offset relation therefrom, while leaving air-filled void spaces bound by said additional spacer boards between the interior insulation panels and said interior finishings.

15. The wall assembly of claim 14 further comprising one or more utilities installed within the wall assembly, and comprising utility componentry occupying one or more of the air-filled void spaces.

16. The wall assembly of claim 15 wherein said utility componentry comprises one or more electrical boxes installed among said one or more of the air-filled void spaces, and electrical wiring routed to said one or more electrical bosses through at least one of said one or more of the additional air-filled void spaces.

17. A method of assembling the wall assembly of claim 1, said method comprising:
laying a first one of either the interior insulation panels or the exterior insulation panels down atop a support in a batten-down orientation;
laying the spacer boards atop said first one of either the interior insulation panels or the exterior insulation panels, and fastening said spacer boards to the battens of said first one of either the interior insulation panels or the exterior insulation panels thereof through the foam cores thereof;
laying a second one of either the interior insulation panels or the exterior insulation panels atop the fastened spacer boards in a batten-up orientation, and fastening said second one of either the interior insulation panels or the exterior insulation panels to the fastened spacer boards through the foam cores of said second one of either the interior insulation panels or the exterior insulation panels, whereupon the interior insulation panels, the spacer boards and the exterior insulation panels are now fastened together into an assembled unit.

18. The method of claim 17 wherein said first one of either the interior insulation panels or the exterior insulation panels is said interior insulation panels, and said second one of either the interior insulation panels or the exterior insulation panels is said exterior insulation panels.

19. (canceled)

20. (canceled)

21. A wall assembly comprising:
an interior insulation layer that comprises insulation panels each having a foam core, two opposing faces, and plurality of perimeter edges, of which said two opposing faces comprise an interior face for facing toward an interior space of a building and an exterior face for facing away from said interior space of the building;
a set of battens recessed into the foam cores of the insulation panels at the interior faces thereof; and
a set of spacer boards installed on the interior faces of the insulation panels, in fastened relation to the set of battens, and arranged to accept indirect mounting of interior finishings onto the insulation panels in offset relation therefrom, while leaving air-filled void spaces bound by said spacer boards between the interior insulation panels and said interior finishings.

22. The wall assembly of claim 21 further comprising, for each insulation panel, a respective laminated facer laminated onto the foam core of the insulation panel at the interior face thereof, in overlying relation to the set of battens recessed therein.
